(19) United States
(12) Patent Application Publication
(10) Pub. No.: US 2006/0191620 A1
(43) Pub. Date: Aug. 31, 2006

(54) PNEUMATIC TYRE INCLUDING AT LEAST ONE REINFORCING LAYER

(76) Inventors: Rodolfo Noto, Milano (IT); Gaetano Lo Presti, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/532,536

(22) PCT Filed: Dec. 20, 2002
(86) PCT No.: PCT/IB02/05537

§ 371 Date: Feb. 15, 2006

(51) Int. Cl. B60C 15/00

(52) U.S. Cl. 152/540; 152/550; 152/555

(57) ABSTRACT

A pneumatic tyre for a vehicle wheel includes a toroidal carcass, a tread band, a belt structure, and at least one reinforcing layer associated with the carcass. The carcass includes at least one carcass ply having a substantially continuous right-section profile. The carcass has a central crown portion and two axially opposite sidewalls. Each sidewall terminates with a bead for mounting the tyre on a corresponding rim. Each bead includes at least one reinforcing core. The tread band is disposed crownwise, coaxially extending around the carcass, and includes a raised pattern for rolling contact with the ground. The belt structure is coaxially interposed between the carcass and the tread band. The tyre has a size ratio f/H less than 0.2:1. The at least one reinforcing layer is disposed radially external to a point of maximum axial width of the carcass and axially external to the belt structure.

The present invention relates to pneumatic tyres for vehicle wheels provided with a reinforced structure.

A traditional tyre comprises a carcass of toroidal conformation having a central crown region connected at its ends with a pair of axially opposite sidewalls extending radially inwardly, each of them terminating with a bead intended for anchoring of the tyre to a corresponding mounting rim. To this aim a reinforcing metal bead core or bead ring is incorporated into the bead.

Coaxially arranged crownwise of said carcass is a tread band for rolling contact of the tyre on the ground, provided with a raised pattern defined by cuts and grooves formed in the band thickness which are adapted to ensure the necessary behavioural qualities of the tyre in use.

The carcass-reinforcing structure comprises at least one ply of rubberised fabric consisting of a rubber sheet in which textile or metallic reinforcing cords are buried which are disposed transversely of the circumferential tyre direction: in radial-ply tyres the direction of said cords is orthogonal to said circumferential direction, i.e. to the equatorial plane of the tyre.

Said tyre generally also contemplates a belt structure disposed crownwise of the carcass, interposed between the carcass and tread band and extending from one tyre sidewall to the other, i.e. substantially as wide as the tread band itself.

Said structure traditionally comprises one or more strips of rubberised fabric provided with reinforcing cords parallel to each other in each strip and crossed with the cords of the adjacent strips, preferably symmetrically inclined to the equatorial plane of the tyre.

Preferably said belt structure at a radially external position, at least at the ends of the underlying strips, also comprises a further layer of circumferentially disposed (0 degree) textile or metal cords.

The mounting rims of the tyre at their axial ends have two coaxial surfaces generally of substantially conical shape constituting the support seat for the tyre beads, usually known as bead seats. The axially external edge of these seats terminates with a projecting border extending radially outwardly and usually referred to as rim flange, which is adapted to support the axially external surface of the bead and against which said bead is held in abutment by the tyre-inflating pressure.

Forcing of the tyre bead into its seat is ensured by the outwardly-open conical shape of the support seat in co-operation with the reinforcing metal bead ring contained in the tyre bead: this forcing created by the axial thrust exerted onto the bead side axially from the inside to the outside, due to the tyre-inflating pressure, ensures stability of the tyre bead on the rim in use and, in tubeless tyres, airtightness between the tyre and rim as well, so as to prevent a progressive tyre deflation.

Following known manufacturing techniques, as shown in document EP 928 680 in the name of the same Applicant for example, a tyre is directly built on a toroidal support through superposition on the support itself of an elementary semifinished product of appropriate sizes in the form of coils disposed in axial side by side and/or radial overlapping relationship that are wound up thereon in a step immediately following manufacture of said semifinished product. In particular, three different types of elementary semifinished products are used and namely: a section member of elastomer material alone, having a substantially rectangular section, hereinafter referred to as “elongated element”; a strip of elastomer material into which elongated reinforcing elements, typically textile or metallic cords are incorporated, hereinafter referred to as “strip-like element”; and rubberised threads or metal cords as such.

To the aims of the present invention it should be pointed out that by the term “elastomer material” it is intended a composition comprising at least one elastomer polymer and at least one reinforcing filler. Preferably this composition further comprises additives such as cross-linking agents and/or platicizers, for example. Due to the presence of cross-linking agents, this material can be cross-linked through heating, so as to form the final product.

In pneumatic tyres and in particular in those of the tubeless type, intended for medium/heavy duty transport, the bead region is a very critical area often suffering for structural yielding well before complete wear of the tread band, causing the tyre to go out of use.

Patent U.S. Pat. No. 5,587,030 depicts a tyre with a carcass preferably formed of a series of circumferential coils being part of a strip formed from a matrix of elastomer material reinforced with cords disposed in side by side relationship and transversely extending in the strip, the coils of said strip being such disposed that when viewed in radial section show at least some overlapping. If control of the tyre shape is wished when the tyre is inflated on the wheel, zero-degree cords can be added into the sidewalls or at least one wide portion thereof, cord deposition at a varying density being allowed.

WO 00/34059 in the name of the same Applicant describes a tyre for vehicle wheels comprising a carcass of toroidal conformation having a central crown portion and two axially opposite, sidewalls terminating with a pair of beads for anchoring of the tyre to a corresponding mounting rim, each bead comprising at least one annular reinforcing core, a tread band disposed crownwise and coaxially extending around said carcass, said tread band being provided with a raised pattern for rolling contact with the ground, and a belt structure coaxially interposed between said carcass and tread band, said carcass being provided with a reinforcing structure substantially consisting of at least one ply of rubberised fabric, reinforced with metallic cords lying in radial planes containing the tyre rotation axis, said reinforcing structure having its ends anchored to said annular reinforcing core, and a neutral profile lying in a radial right-section plane, axially extending from bead to bead, in which said neutral profile intersects the right section of the field enclosing said annular reinforcing cores, and inwardly not beyond the radially innermost profile of said annular reinforcing cores, said neutral profile along its extension between said beads having a continuous bending devoid of inflexion points.

The Applicant could ascertain that the embodiment disclosed in said document enables important improvements to be obtained in terms of tyre behaviour in use. In fact, by imposing passage of the neutral profile of the carcass plies within the bead ring, preferably through the bead ring centre of gravity, so that the inflexion point is in this way eliminated, it is possible to substantially reduce the twisting moment discharged by the carcass plies onto the core in the tyre inflated to the working pressure. Said twisting moment, during operation of the tyre, varies at each tyre rotation cycle thereby producing cyclical micro-movements in the whole bead structure (in particular micro-rotations of the bead around its axially external corner) which can give rise to structural yielding in more or less extended periods of time.

The Applicant could however experiment that the carcass structures devoid of a turned-up portion around the bead rings like those disclosed in the above mentioned documents can have some dynamic-behaviour problems with respect to those made in the traditional manner, above all when loads exceed the standard use conditions. In fact the structural stiffness of the turned-up carcass portion possibly associated with reinforcing edges at the bead region distributes the stresses within the bead itself in a more uniform manner, said stresses depending on the amount of deformations imposed by the load.

In addition, the carcass structure made following recent technologies and devoid of a turned-up portion at the beads carries out discharging of the stresses imposed by the load onto the bead region, leaving to possible local reinforcing elements present in that region the task of reducing outward displacements of the bead towards the rim flange as best as possible.

In this way the state of stress at the beads becomes higher than obtainable in traditional beads provided with a turned-up portion of the carcass ply, the other conditions being the same.

The Applicant has become aware of the fact that by controlling the maximum tyre deflection when the tyre is submitted to a load, stresses and possible consequent deformations at the bead region are reduced. This makes the requirement of adding reinforcing elements in the same bead region less urgent. In more detail, the Applicant could ascertain that during a rolling cycle, taking into account a radial carcass with a uniform cord density, the distance between the carcass cord centres varies depending on the circumferential and radial positions. In particular under the footpring, the distance between centres increases in a substantially proportional manner until reaching the maximum footprint width. Consequently the Applicant could perceive that by controlling the distance between the carcass cord centres under the footprint, deflection of the tyre submitted to a load can be reduced which will bring about a reduction in the state of stress at the beads.

The Applicant could find that by linking up the carcass cords with each other by the presence of a layer of reinforcing material at a radially and axially external position with respect to said carcass ply, at least close to the tyre shoulders, tyre deformation in the footprint region is greatly reduced thereby ensuring a more reduced state of stress at the beads.

In a first aspect, the invention relates to a pneumatic tyre for vehicle wheels having a size ratio f/H less than 0.2, comprising a toroidal carcass having a central crown portion and two axially opposite sidewalls terminating with a pair of beads for anchoring of the tyre to a corresponding mounting rim, each bead comprising at least one annular reinforcing core, a tread band placed crownwise, coaxially extending around said carcass and provided with a raised pattern for rolling contact with the ground, and a belt structure coaxially interposed between said carcass and tread band, said carcass comprising at least one carcass ply having a continuous right-section profile, the ends of said ply extending in a radially external direction not beyond half the radial height of said annular reinforcing elements, wherein said tyre comprises at least one reinforcing layer associated with said carcass, at a radially external position relative to a point of maximum axial width of said carcass and at a position axially external to said belt structure.

Further features and advantages of the invention will become more apparent from the detailed description of some preferred but not exclusive embodiments of a pneumatic tyre for vehicle wheels with a reinforced structure in accordance with the present invention. This description will be set out hereinafter with reference to the accompanying drawings given by way of non-limiting example, in which:

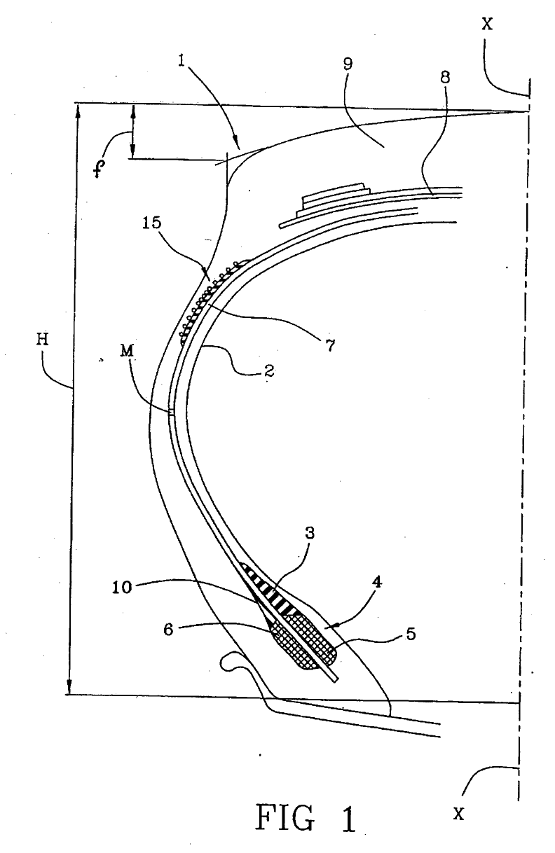

FIG. 1 is a right-section view of a tyre in accordance with the invention;

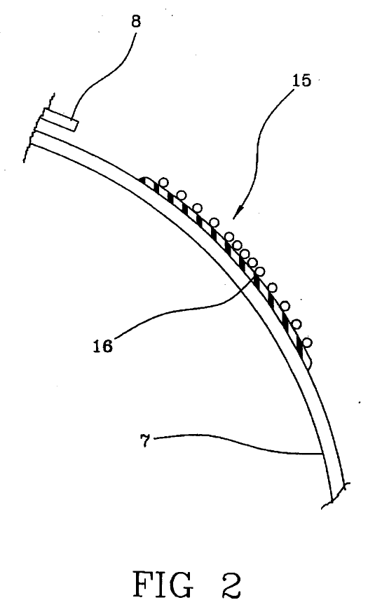

FIG. 2 is a partial right section of the tyre in accordance with a first embodiment of the invention;

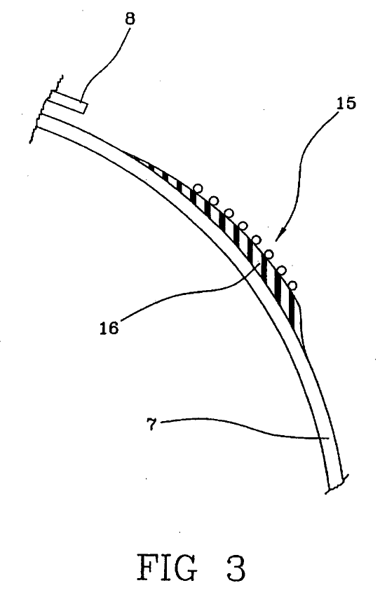

FIG. 3 is a partial right-section view of the tyre in accordance with a further embodiment of the invention.

In the following reference will be made to the neutral profile of the carcass ply/plies: such a profile is coincident with the carcass ply profile when there is only one ply or when two or more plies are in mutual contact, but diverges therefrom when said plies move away from each other. In this case the neutral profile corresponds to the profile of the neutral axis of the assembly externally bounded by said plies.

FIG. 1 diagrammatically shows a first preferred embodiment of tyre 1 in accordance with the invention, said tyre comprising a carcass of toroidal conformation having a central crown region connected at its ends with a pair of axially opposite sidewalls, extending radially inwardly and each terminating with a bead intended for anchoring of the tyre to a corresponding mounting rim. Said tyre 1 preferably also comprises a sheet 2 of elastomer material called “liner” at a radially internal position with respect to said carcass, at least one annular reinforcing core within said beads, fillers of elastomer material at a position radially external to said at least one annular reinforcing core, a belt structure 8, coaxially disposed crownwise of said carcass and interposed between said carcass and a tread band 9, said carcass comprising at least one carcass ply 7 having a homogeneous, i.e. substantially continuous, profile in right section. Said tyre, as better illustrated in the following, further comprises at least one reinforcing layer 15 associated with said carcass, at least at a radially external position with respect to a point M of maximum axial width of the carcass and at an axially external position relative to said belt structure 8.

Preferably, the inventive tyre is a pneumatic tyre for cars or heavy duty vehicles in general having a side ratio f/H less than 0.2, wherein arrow “f” is the height in right section measured in a radial direction between the intersection point of the extension in an axially external direction of the tread band curvature with the extension in a radially external direction of the sidewall curvature, and the parallel to the fitting line passing through the radially external point of the tread band itself, and “H” is the distance in right section between the parallel to the fitting line passing through the radially external point of the tread band and the fitting line itself (FIG. 1).

Preferably, said tyres are dedicated to transportation of goods or persons and are intended for both road and off-road use, irrespective of their position on the vehicle. In addition they are used on mounting rims having an inclined base, preferably with an inclination included between 0° and ±25°.

Said tyre 1 is preferably obtained following the technology described in the already mentioned EP 0 928 680 in the name of the same Applicant.

In short, said tyre 1 is preferably directly formed on a toroidal support (not shown) by superposition on the support itself of an elementary semifinished product of appropriate sizes in the form of coils disposed in axial side by side and/or radially overlapping relationship that are wound up thereon in a step immediately following manufacture of the semifinished product.

More particularly, laid down on a toroidal support the outer profile of which is substantially coincident with that of the inner surface of the green tyre, are the inner elements of tyre 1, starting from the so-called liner 2 that in a tubeless tyre constitutes the air-tight inner tyre surface. Said liner 2 is laid down on said toroidal support preferably through spiralling of an elongated element of elastomer material.

Before making said at least one carcass ply 7, one or more elastomer fillers 3 having a shape tapering radially outwardly in the right section of tyre 1, as shown in. FIG. 1, are laid down on said toroidal support.

A first annular reinforcing core is also formed at a radially internal position with respect to said elastomer filler 3. Preferably, said annular reinforcing core comprises a bead ring 5 preferably made of a set of coils of metal wire disposed radially superposed and in axial side by side relationship. Said set of coils can be made by winding up on said support or on a different building drum, a plurality of coils that are radially superposed on themselves and in axial side by side relationship, said coils being made of a metal wire or, alternatively, consisting of a cord of metallic wires, of a ribbon made up of said wires or cords, or also of a metal strap.

The material forming the bead ring can be any textile or metallic material or a material of different nature provided with appropriate mechanical-strength features; preferably this material is standard or high-tensile steel, commonly used in tyre technology and preferably employed in the form of a metallic cord.

The tensile strength of each wire forming said cord may vary between 500 and 5000 N/wire. Preferably said cord is of the 7×3×0.30 type (i.e. a cord made up of 7 strands of three wires each, each wire being of a 0.3 mm diameter) made of high-tensile steel.

Then construction of the carcass structure, i.e. of at least one carcass ply 7, is carried out by laying down on said toroidal support, in a circumferential succession, a plurality of strip-like elements, i.e. strips of rubberised fabric each containing a given number of cords in which the cords are radially disposed, i.e. at 90° relative to the circumferential direction of the support. Said strip-like elements are caused to adhere to the underlying layers over the whole longitudinal extension thereof going from bead to bead along the outer surface of the support itself.

Each strip-like element is preferably formed by sequentially cutting a continuous elongated element (not shown) previously made, into a plurality of sections of predetermined length, each section forming one of said strip-like elements, as described in document EP 0 976 535 in the name of the same Applicant, for example.

Once manufactured, each strip-like element is laid down onto said toroidal support giving the same a U-shaped configuration around the cross-section profile of the toroidal support itself, so that in said strip-like element two side portions can be identified that radially extend towards the toroidal-support axis, at positions axially spaced apart from each other, as well as a crown portion extending at a radially external position between the side portions themselves.

Said toroidal support can be driven in angular rotation in a step-by-step movement in synchronism with the step of laying down said strip-like element, in such a manner that each strip-like element is laid onto the toroidal support preferably to a position circumferentially spaced apart from the previously laid down strip-like element. In this way, after one or more revolutions of the toroidal support around its rotation axis, the carcass ply 7 is fully built on said toroidal support, thereby forming a continuous layer. To the aims of the present description, it is to be pointed out that if not otherwise stated, the term “circumferential” refers to a circumference lying in the equatorial plane X-X and close to the outer surface of the tyre.

Preferably the strip-like elements of a width included between 3 mm and 15 mm and of a thickness in the range of 0.5 mm to 2.5 mm, contain a number of cords included between 2 and 15, with a density preferably of 2 to 10 cords/cm, measured on the carcass ply in a circumferential direction, in the vicinity of the equatorial plane of tyre 1.

The Applicant found it preferable to use a metal cord selected from those usually adopted in the manufacture of tyre carcasses, with an elementary wire of a diameter included between 0.14 and 0.23 mm, in a formation of the 7×4×0.175 WLL type (wrapped cord) with densities as above pointed out.

Going on in making said tyre 1, preferably at a radially external position with respect to said point M of maximum axial width of the carcass and at an axially external position to said belt structure 8, i.e. in the shoulder region, said reinforcing layer 15 is made through deposition of same on said toroidal support.

Said layer 15 may comprise both spiralled cords having an appropriate winding pitch, and an elastomer material reinforced with fibres (short aramidic fibres, such as Kevlar® Pulp, for example) laid down on said toroidal support by means of the already described techniques for liner deposition (i.e. spiralling of elongated elements of said reinforced elastomer material) as well as an assembly of cords and elastomer material reinforced with fibres.

Preferably said layer 15 further comprises a substrate 16 preferably of elastomer material (laid down in the same manner as said liner) that, as better illustrated in the following, becomes a true interface between the carcass ply and the structurally significant elements of said reinforcing layer 15, i.e. the cords and/or said reinforced elastomer material. Said substrate 16 too may comprise said elastomer material reinforced with fibres.

Said substrate 16 preferably is manufactured following two preferred embodiments as regards configuration, as shown in FIGS. 2 and 3. In more detail, said substrate 16 may have a constant thickness (FIG. 2) or a varying thickness (FIG. 3) depending on the features selected for layer 15. If laying down of the cords takes place with a varying deposition pitch, a substrate 16 of constant thickness is preferred, whereas in the case of laying down of cords with a constant deposition pitch, a varying thickness for said substrate 16 is preferred.

More particularly, said interface substrate 16 may have a varying thickness depending on the radial height, preferably in inverse proportion thereto, if laying down (spiralling) of the cords occurs at a constant pitch, whereas it may have a constant thickness if laying down of the cords takes place at a pitch varying with the radial height.

These different embodiments of tyre 1 in accordance with the invention originate from the specific features that the reinforcing layer 15 taken as a whole must possess.

In fact, considering a radial carcass in which the cords have a uniform density like that formed of said previously illustrated ply 7, during rolling of tyre 1 incorporating it on a road, it may happen that the distance between centres of said carcass cords should vary depending on the circumferential position and the radial position. In fact, as compared with the condition of an inflated tyre under static conditions in which the distance between the cord centres substantially varies only depending on the radial position, in the case of the tyre during rolling, since the carcass is secured to the bead by the above mentioned annular reinforcing elements and connected to the belt in the crown portion thereof, the following can be stated.

Under the footpring the distance between centres increases in a proportional manner until a maximum and then decreases; before and after entry and exit from the footprint area the distance between centres decreases until reaching a minimum point; at 90° (circumferentially measured) from the footprint the distance between centres substantially has the features present under static conditions; at 180° from the footprint the distance between centres is smaller due to the greater tensioning on the carcass ply resulting from the structural rigidity of the belt to which it is linked.

The Applicant has verified that a control on tyre deflection in use consequently limits the state of stress present on the beads, and has found that tyre deflection is closely connected with the distance between centres of the carcass ply cords under the footprint, so that through control of said distance between centres the state of stress on the beads can be reduced. In order to control said distance between centres, the Applicant found it particularly convenient to constrain said cords through deposition of said reinforcing layer 15. In fact, the constraints imposed by said layer to the underlying carcass cords, help in greatly reducing the amount of total deformation of the tyre in the footprint region ensuring a lower stress state.

The above statements justify the different embodiments discussed above in relation to layer 15. Said reinforcing layer has a high resistance to stresses along its longitudinal axis and a parabolic elongation behaviour, i.e. in a stress/deformation diagram a parabolic curve of slight slope is obtained.

Substantially, there are three significant structural elements for the tyre in accordance with the invention: the mechanical features of the cords therein employed; the mechanical features of layer 15 (spiralling pitch); thickness and fatigue features of the interface material (preferably elastomer) of substrate 16.

In fact, in the regions of greater deviation from the distance between centres, the cords must be able to support the load imposed by the carcass deformation but they must not be too stiff, at least at the starting deformation stretch in order not to overload the interface material/s. This is valid both in traction and in compression.

For the same reason, deposition adjustment (and, consequently, adjustment of the cord layer) takes place depending on the radial region on which it is carried out. In fact laying down is executed in order to obtain the maximum possible constraint trying to avoid breaking of the elastomer material in the substrate 16 and/or buckling of the individual cords, in addition to achieving excellent handling and comfort performance. The pitch will therefore be a function of the radial height determining deviation of the carcass cords, the utilised material and the concerned region. In fact, carrying out spiralling also in regions where the behavioural result in the terms as above described is not particular effective could be convenient, i.e. where it has no influence for achieving an effective reduction in the state of stress at the beads, but is adapted to give the tyre a continuity of behaviour without a high stiffness gradient close to the shoulder region.

Subsequently to making said reinforcing layer 15, at a position axially external to said carcass ply 7, a second annular reinforcing core is preferably laid down at a position axially external to said bead ring 5 and preferably at the same radial height as the latter. This second annular reinforcing core too comprises a bead ring 6, substantially in the shape of an annulus concentric with the rotation axis of the tyre and consisting of at least one elongated metal element wound in several substantially concentric coils disposed radially superposed and in axial side by side relationship. The coils can be defined by a continuous spiral or by concentric rings formed of the respective elongated metal elements.

Then, optionally, deposition of other elongated elements of elastomer material employed as fillers 10 for the bead region can follow. Obviously deposition of the carcass ply 7 can be followed by deposition of a second carcass ply through the same modalities. In this case formation of the reinforcing layer 15 is carried out after making said second ply, i.e. when the carcass structure has been completed.

Subsequently deposition of the other constituent elements of tyre 1 will take place, i.e. the belt structure 8 and tread band 9.

It should be noted that the assembly of the right-section areas of said bead rings 5 defines a field 4 containing said bead rings. Preferably said field 4 substantially delimits the right-section area taken up by said bead rings.

In a preferred embodiment of tyre 1, the ends of said ply extend in a radially external direction not beyond half the radial height of said annular reinforcing elements, or at all events they do not turn up around said bead rings 5, 6.

In a further preferred embodiment (FIG. 1) of the tyre in accordance with the invention the neutral profile of the carcass ply/plies along the extension of same between the beads has a continuous curvature devoid of inflection points and in addition passage of said neutral profile within said field 4, and preferably through the centre of gravity of the bead ring assembly avoids the assembly of said bead rings being submitted to a twisting moment, go that said assembly must exclusively withstand the tensile stresses applied to its right section by effect of forcing on the bead seat. This embodiment coupled with said reinforcing layer 15 optimises the tyre behaviour in use still to a greater extent, because the state of stress is kept low due to a more reduced tyre deflection for the presence of said layer 15, whereas the particular bead geometry prevents the state of stress at all events present from giving rise to cyclical stresses during rolling, so that a high duration of the tyre is obtained, the running conditions being the same.

In one embodiment (for a tyre model 315/80 R 22.5, for example), the Applicant employed cords of the High Elongation (HE) type for layer 15, and more particularly cords made in accordance with a 3×7×0.20 formation i.e. using 3 strands of 7 wires of 0.2 mm diameter wound up so as to give a high starting elongation. Said cords are spirally wound with a varying pitch and with a centre of gravity at about 25 mm (measured in a radial direction) from separation of the belt structure-carcass assembly, said pitch being of greater density over a length preferably of 15 mm measured in a radial direction (said length substantially starting at 7.5 mm in a direction radially external to the centre of gravity and substantially terminating at 7.5 mm in a direction radially internal to the centre of gravity), said pitch progressively widening upwardly until reaching said belt structure and downwardly until a distance of about 45-50 mm still measured in a radial direction starting from said belt structure. In this case for substrate 16 a constant thickness of about 0.8-1 mm of elastomer material was used (FIG. 2).

In another embodiment (still using the same tyre model), the Applicant for said layer 15, with the same type of cords, used a spiralling of constant pitch at a very particular carcass region at the shoulder, determined by a study carried out on the finished elements. In this case a thickness of elastomer material for said substrate 16 was used which varied with the radial deposition height in order to limit the state of stress at the crossing points between the cords of the carcass ply 7 and those of the reinforcing layer 15 (FIG. 3).

The Applicant verified that tyre 1 in accordance with the invention has an effective deflection reduction, the load being the same, as compared with a tyre having the same sizes but devoid of the reinforcing layer 15, said reduction being of about 4.5% in the tested tyre and giving rise on the whole to a net performance improvement being the beads less stressed. More specifically, an indoor test was carried out at a speed of 20 km/h on tyres of the 315/80 R 22.5 type (the tyre in accordance with the invention was obtained following the last-described embodiment) inflated to 9 bars and loaded to 8640 kg: there was a change in deflation from about 86 mm to about 82 mm.

1-14. (canceled)

15. A pneumatic tyre for a vehicle wheel, comprising:
a toroidal carcass;
a tread band;
a belt structure; and
at least one reinforcing layer associated with the carcass;
wherein the carcass comprises at least one carcass ply having a substantially continuous right-section profile,
wherein the carcass has a central crown portion and two axially opposite sidewalls, wherein each sidewall terminates with a bead for mounting the tyre on a corresponding rim,
wherein each bead comprises at least one reinforcing core,
wherein the tread band is disposed crownwise, coaxially extending around the carcass,
wherein the tread band comprises a raised pattern for rolling contact with the ground,
wherein the belt structure is coaxially interposed between the carcass and the tread band,
wherein the tyre has a size ratio f/H less than 0.2:1, and
wherein the at least one reinforcing layer is disposed radially external to a point of maximum axial width of the carcass and axially external to the belt structure.

16. The tyre of claim 15, wherein ends of the at least one carcass ply extend in a radially external direction not beyond half a radial height of respective reinforcing cores.

17. The tyre of claim 15, wherein ends of the at least one carcass ply do not turn up around respective reinforcing cores.

18. The tyre of claim 15, wherein the at least one reinforcing layer comprises a substrate.

19. The tyre of claim 18, wherein the substrate comprises an elastomer material.

20. The tyre of claim 19, wherein the elastomer material is reinforced with fibers.

21. The tyre of claim 15, wherein the at least one reinforcing layer comprises a plurality of cords.

22. The tyre of claim 15, wherein the at least one reinforcing layer comprises a plurality of high-elongation-type cords.

23. The tyre of claim 21, wherein the at least one reinforcing layer comprises a substrate of a varying thickness depending on radial height, and
wherein the cords are spiraled at constant pitch.

24. The tyre of claim 21, wherein the at least one reinforcing layer comprises a substrate of substantially constant thickness, and
wherein the cords are spiraled at varying pitch depending on radial height.

25. The tyre of claim 15, wherein the at least one reinforcing layer comprises an elastomer material reinforced with fibers.

26. The tyre of claim 25, wherein the fibers comprise aramidic fibers.

27. The tyre of claim 15, wherein the at least one reinforcing core comprises:
a bead ring;
wherein the bead ring comprises a set of coils of metal wire disposed radially superposed on each other and in axial side-by-side relationship.

28. The tyre of claim 15, wherein an extension of the at least one carcass ply between the beads comprises a neutral profile with a continuous curvature devoid of inflection points.

29. The tyre of claim 15, wherein an extension of the at least one carcass ply between the beads comprises a neutral profile passing within fields delimiting an assembly of right-section areas of respective bead rings.

30. The tyre of claim 15, wherein an extension of the at least one carcass ply between the beads comprises a neutral profile passing through a center of gravity of respective bead rings.
